(19) United States
(12) Patent Application Publication
(10) Pub. No.: US 2021/0061336 A1
(43) Pub. Date: Mar. 4, 2021

(54) TRANSPORTING APPARATUS

(71) Applicant: WAYWILLING LIMITED, MASTERTON (NZ)

(72) Inventor: WILLIAM ROWLAND, MASTERTON (NZ)

(21) Appl. No.: 16/890,906

(22) Filed: Jun. 2, 2020

(30) Foreign Application Priority Data
Aug. 29, 2019 (NZ) 756848

(51) Int. Cl. B62B 5/08; B62B 5/00; B62B 5/04; B62B 3/00

(52) U.S. Cl. CPC B62B 5/087; B62B 5/004; B62B 5/0053; B62B 2301/08; B62B 3/001; B62B 3/008; B62B 5/04

(57) ABSTRACT

A transporting apparatus comprising: a standing platform adapted for a user to stand on and wherein the platform has at least two wheels connected to it; a carrying means; a base with at least two drive wheels associated with it and wherein the base is connected to the standing platform; a drive motor which is in communication with the at least two drive wheels and with an accelerating means; and an accelerating means which is in communication with the drive motor; the apparatus is adapted such that when in use a user is able to load items into the carrying means and then stand on the platform and then engage the accelerating means which results in the apparatus moving forward.

### FIELD OF INVENTION

The invention generally relates to a transporting apparatus. More particularly, but not exclusively the invention relates to a transporting apparatus which can transport a user and items and also to a method of transporting a user and items with the apparatus.

### BACKGROUND

Carrying items such as wood from one location to another can be inconvenient, unduly labour intensive and time consuming. In order to the address this problem products such as handcarts and wheelbarrows can be used. However, pushing handcarts and wheelbarrows can still be physically demanding to the user.

It is an object of a preferred form of the present invention to go at least some way towards addressing the above problem. While this is an object of a preferred embodiment, it should not be seen as a limitation on the scope of the invention as claimed. The object of the invention per se is simply to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in the United States or in any other country.

The term “comprising” and derivatives thereof, eg “comprises”, if and when used herein in relation to a combination of features should not be taken as excluding the possibility that the combination may have further unspecified features. For example, a statement that an arrangement “comprises” certain parts does not mean that it cannot also, optionally, have additional parts.

### SUMMARY OF THE INVENTION

According to one aspect of the invention there is provided a transporting apparatus comprising:
a standing platform adapted for a user to stand on and wherein the platform has at least two wheels connected to it;
a carrying means (e.g. wheelbarrow bucket);
a base with at least two drive wheels associated with it and wherein the base is connected to the standing platform;
a drive motor which is in communication with the at least two drive wheels and with an accelerating means; and
an accelerating means (e.g. a lever) which is in communication with the drive motor;

the apparatus is adapted such that when in use a user is able to load items into the carrying means and then stand on the platform and then engage the accelerating means which results in the apparatus moving forward.

Preferably the apparatus has a steering mechanism.

Preferably the steering mechanism is a steering bar.

Preferably the steering mechanism is handle bars.

Preferably the steering mechanism is a steering wheel.

Preferably the accelerating means is a lever.

Preferably the accelerating means is a foot pedal.

Preferably the carrying means is connected to the base.

Preferably the carrying means has one wheel connected to the front of it.

Preferably carrying means is a bucket of a wheelbarrow.

Preferably the carrying means is located at the front of the apparatus.

Preferably the apparatus has two handles and wherein a steering bar is connected to the handles.

Preferably the handles are connected to the base and to the carrying means.

Preferably the handles have a front wheel connected to them.

Preferably the handles are connected to the front of the bucket by support members.

Preferably the drive motor is electric.

Preferably the drive motor is a mobility scooter motor.

Preferably the apparatus has a rechargeable battery.

Preferably the wheels are pneumatic tyres.

Preferably the apparatus has a control housing.

Preferably the control housing has a recharging port which is arranged to recharge the battery.

Preferably the apparatus has a means to control speed.

Preferably the means to control speed is a dial which is turned clockwise to increase speed and anti-clockwise to decrease speed.

Preferably the means to control speed is located in the control housing.

Preferably the motor is turned on and off by a key.

Preferably the motor is turned on and off by a switch.

Preferably the apparatus has breaking means.

Preferably the standing platform is connected to the base by a towing bar.

Preferably the standing platform has two wheels.

Preferably the standing platform is located at the rear of the apparatus.

Preferably the apparatus has a reverse function.

Preferably the standing platform is made substantially from steel.

Preferably the apparatus has a bell or a horn.

In a second aspect of the invention there is provided a method of transporting a user and items with the previously described apparatus.

These and other features, objects and advantages of the present invention will be readily apparent to persons of ordinary skill in the art upon reading the entirety of this disclosure, which includes the accompanying drawings.

### BRIEF DESCRIPTION OF THE DRAWINGS

Some preferred embodiments of the invention will now be described by way of example and with reference to the accompanying drawings, of which:

FIG. 1 is a side view of a transporting apparatus;

FIG. 2 is an end view of the transporting apparatus; and

FIG. 3 is perspective view of the transporting apparatus when in use.

### DETAILED DESCRIPTION

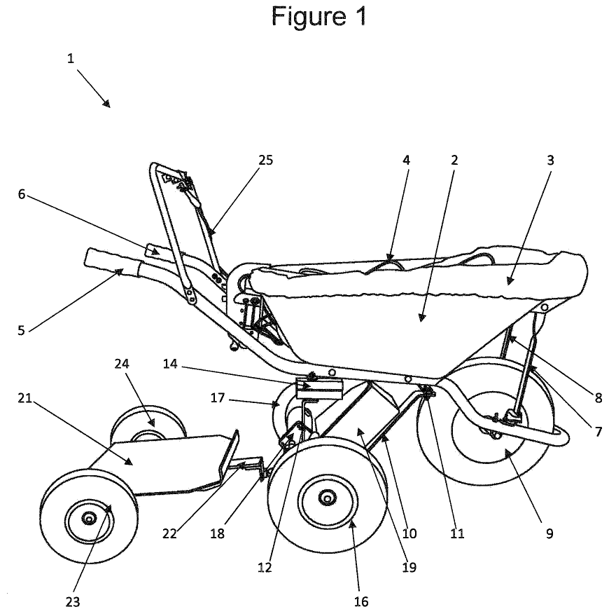

FIG. 1 shows a transporting apparatus 1 which can be used to transport items as well as a user/person. As can be seen the apparatus 1 has a wheelbarrow bucket 2 for receiving and carrying items. The bucket 2 shown has a removable plastic bag 3 covering the inside of it and the bucket 2 has pieces of scrap metal 4 loaded into it. Those skilled in the art will appreciate that instead of a wheelbarrow bucket 2 different suitable shaped containers (e.g. square, rectangular etc) can be used as the carrying means. As shown the bottom of the bucket 2 is connected to two handles 5, 6 by fastening means such as screws or bolts and the like and the bucket 2 is also connected to the handles 5, 6 via two front support members 7, 8 by fastening means or the like. As shown the apparatus 1 has a front tyre 9 which is connected to the handles 5, 6.

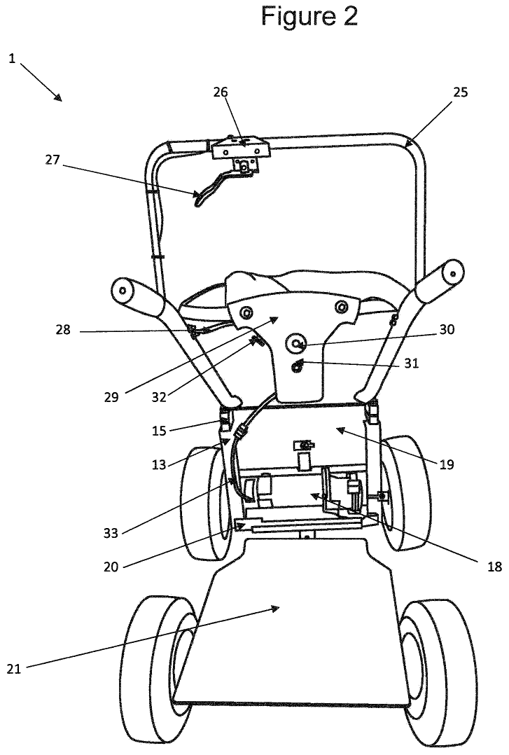

The apparatus 1 also has a base which comprises two angled base members 10 (only one is visible) which connect to a horizontal base member 11 which connects to the handles 5, 6 and two vertical base members 12, 13 (13 is visible in FIG. 2) which are connected to the handles 5, 6 by a pair of spacers 14, 15 (15 is visible in FIG. 2). The base has two wheels 16, 17 and has electric motor 18 which powers the base wheels 16, 17. The wheels 16, 17 are preferably stone resistant and/or puncture resistant. In some embodiments the apparatus 1 can have more than two drive wheels 16, 17. The electric motor 18 shown in the drawings is an electric mobility scoter motor 18 however any suitable motor can be used. The apparatus 1 also has a rechargeable battery 19 which powers the electric motor 18. The motor 18 and battery 19 are connected to the base members 10, 12, 13 to support them. The base also has a cross member 20 (visible in FIG. 2) and this connects to a standing platform 21 via a connecting member 22 such as a tow bar or the like. The standing platform 21 which is preferably made from steel has two wheels 23, 24 however in some embodiments the platform 21 may have more wheels. The apparatus 1 also has steering bar 25 which is connected the handles 5, 6 and is used for steering. In some embodiment the ends of the handles 5, 6 may be removed i.e. the handles terminate where the steering bar 25 is connected to them. In alternative embodiments instead of a steering bar 25 a steering wheel or handle bars may be used. In an alternative embodiment the steering bar 25 may have a cord wrapped around it to make the bar easier to hold and in another embodiment the bar has a grip on it.

FIG. 2 shows parts of the apparatus 1 in more detail. Connected to the steering bar 25 by a mounting means 26 is an accelerator lever 27. A cable 28 connects the lever 27 to a control housing 29. The control housing 29 has a dial 30 for controlling speed and an on/off switch 31. In some embodiments (not shown) a key may be used to turn the motor 18 on and off instead of the switch 31. The control housing 29 also has a charging port 32 for a recharger (not shown) to be plugged into which recharges the battery 19. As shown another cable 33 connects the control housing 29 to the motor 18.

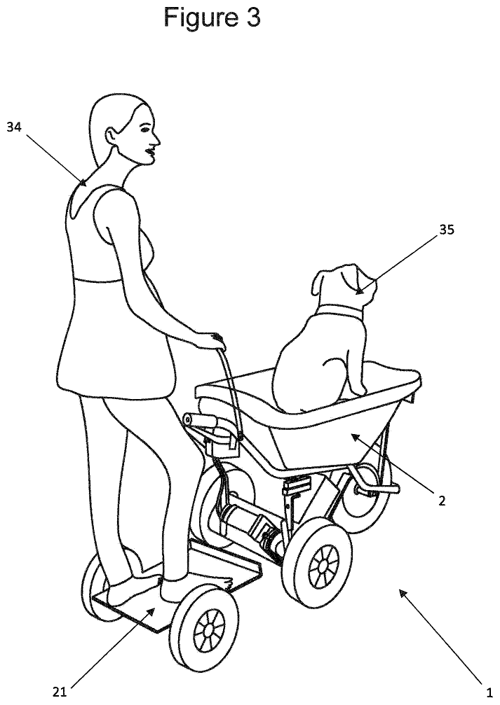

FIG. 3 shows the apparatus 1 when in use. As shown a user 34 is standing on the platform 21 and transporting a dog 35 which is sitting in the bucket 2. In some embodiments the apparatus 1 has a removable rain cover for the bucket.

In a preferred embodiments the apparatus 1 may has a reverse function. In another embodiment the apparatus 1 has lights, indicators, speedometer, brake lever, kill switch to shut the motor off, mirrors, reflectors and/or a horn or a bell. In another embodiment a remote control can be used by the user to accelerate and brake and in a further embodiment a motorcycle throttle can be used as the accelerating means. In another embodiment the apparatus 1 can have a handbrake which operates a disk brake on the wheels 16, 17. In some embodiments there are no handles 5, 6 and the steering bar 25 can be attached directly to the bucket 2. In an alternative embodiment the standing platform 21 can form part of the base (e.g. is not connected to it) and in a further embodiment the platform 21 is shaped such that it is wide or long enough for more than one person to stand on.

In use a user would load items such as groceries, wood, animals or pets etc into the bucket 2. The user would then stand on the standing platform 22 and start the motor 18 via the on/off switch 31 (or key) and select the desired speed on the dial 32. The user would then squeeze the accelerator lever 27 which results in the motor 18 powering the base wheels 16, 17 which results in the apparatus 1 moving forward. To steer the apparatus 1 the user pulls back slightly on the handle bar 25 to lift the front wheel 9 off the ground and then the user is able to point the apparatus 1 in the desired direction. To slow down or stop the apparatus 1 the user would release the accelerator lever 27 or in embodiments with brakes they would engage the brake.

The apparatus 1 can be used for many different activities such as gardening, farming, collecting wood, shopping, exercising a dog or just transporting the user from one location to another.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the transporting apparatus may vary dependent on the particular application for which it is used without variation in the spirit and scope of the present invention. In addition, although the preferred embodiments described herein are directed to a transporting apparatus it will be appreciated by those skilled in the art that variations and modifications are possible within the scope of the appended claims.

1. A transporting apparatus comprising:
a standing platform adapted for a user to stand on and wherein the platform has at least two wheels connected to it;
a carrying means;
a base with at least two drive wheels associated with it and wherein the base is connected to the standing platform;
a drive motor which is in communication with the at least two drive wheels and with an accelerating means; and
an accelerating means which is in communication with the drive motor;
the apparatus is adapted such that when in use a user is able to load items into the carrying means and then stand on the platform and then engage the accelerating means which results in the apparatus moving forward.

2. An apparatus according to claim 1, wherein the apparatus has a steering mechanism.

3. An apparatus according to claim 1, wherein the apparatus has a steering mechanism and wherein the steering mechanism is a steering bar, handle bars or a steering wheel.

4. An apparatus according to claim 1, wherein the accelerating means is a lever or a foot pedal.

5. An apparatus according to claim 1, wherein the carrying means is connected to the base.

6. An apparatus according to claim 1, wherein the carrying means has one wheel connected to the front of it.

7. An apparatus according to claim 1, wherein the carrying means is a bucket of a wheelbarrow.

8. An apparatus according to claim 1, wherein the carrying means is located at the front of the apparatus.

9. An apparatus according to claim 1, wherein the apparatus has two handles and wherein a steering bar is connected to the handles and wherein the handles are connected to the base and to the carrying means wherein the handles have a front wheel connected to them.

10. An apparatus according to claim 1 wherein the drive motor is electric.

11. An apparatus according to claim 1, wherein the drive motor is a mobility scooter motor.

12. An apparatus according to claim 1, wherein the apparatus has a rechargeable battery.

13. An apparatus according to claim 1, wherein the apparatus has a control housing.

14. An apparatus according to claim 1, wherein the apparatus has a control housing. and wherein the control housing has a recharging port which is arranged to recharge a battery.

15. An apparatus according to claim 1, wherein the apparatus has a means to control speed and wherein the means to control speed is located in the control housing.

16. An apparatus according to claim 1, wherein the apparatus has a means to control speed and wherein the means to control speed is located in the control housing and wherein the means to control speed is a dial which is adapted such that if it is turned clockwise this increases the speed and when it is turned anti-clockwise this decreases the speed of the apparatus.

17. An apparatus according to claim 1, wherein the apparatus has breaking means.

18. An apparatus according to claim 1, wherein the standing platform is connected to the base by a towing bar.

19. An apparatus according to claim 1, wherein the standing platform has two wheels and is located at the rear of the apparatus.

20. An apparatus according to claim 1, wherein the apparatus has a reverse function.
